(19) United States
(12) Patent Application Publication
(10) Pub. No.: US 2005/0045681 A1
(43) Pub. Date: Mar. 3, 2005

(54) All terrain vehicle portable radio mount

(76) Inventors: Dennis H. Hancock, Mountain Green, UT (US); Jeffrey D. Hancock, Uintah, UT (US)

Correspondence Address: DENNIS H. HANCOCK, 5752 SILVERSTONE CIRCLE, MOUNTAIN GREEN, UT, 84050, US

(21) Appl. No.: 10/647,181

(22) Filed: Aug. 25, 2003

(51) Int. Cl. B62J 7/06; B60R 7/00; B60R 9/00

(52) U.S. Cl. 224/401; 224/420; 224/929

(57) ABSTRACT

An all terrain vehicle portable radio mount having a base support with a clamping member to be attached to the handlebar of a vehicle, a connector member adjustably positioned on and secured to the base support, a cantilever support angularly adjustable with respect to the connector member and locked to prevent movement therebetween and a backing plate to receive and secure a portable radio.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

1. Field of the Invention

This invention relates to a holder for portable radios that will allow such radios to be easily and removable attached to the handlebars of an all terrain vehicle, snowmobile, motorcycle, or the like.

2. Description of the Related Art

It has been found to be very desirable to be able to carry portable, two-way radios on all terrain vehicles, snowmobiles and motorcycles and the like. The two-way radios allow communication between a base station and a rider on a vehicle or between operators of vehicles. The two-way radios are generally hand held units, although they may include clips for attachment to belts or straps.

The operator of an all terrain vehicle, snowmobile, motorcycle or the like, generally needs to place both hands on the handlebars of the vehicle. Thus, it is not convenient for an operator to try and hold and use a two-way radio while traveling on a vehicle. Nevertheless, it may be highly desirable for an operator of an all terrain vehicle to receive communications from a base station or to converse with other all terrain vehicle operators while traveling.

### OBJECTS OF THE INVENTION

Principal objects of the present invention are to provide a mounting system for securing two-way radios to the handlebars of all terrain vehicles, snowmobiles, motorcycles, or the like. Other objects are to provide a connector system that will allow for the positioning of a great variety of commonly available two-way radios and that can even be used to hold and secure cellular telephones, global positioning units and other such structures.

Other objects are to provide a mounting system that will attach to the handlebars of a vehicle and that will hold the two-way radio, or other held device in a position easily viewed and operated by the operator of the vehicle.

### FEATURES OF THE INVENTION

Principal features of the invention include a handlebar clamp to which a cantilever support is attached. The cantilever support is made to telescope over an upwardly extending end of the clamp and has an interior receptacle shaped to fit over the upwardly extending clamp portion. Both the clamp portion and the interior of the cantilever support are made to be non-circular and to have different alignment positions to provide for adjustment of the position of the supported mount holding a two-way radio, or the like. A bolt inserted through the cantilever support and into the upper end of the clamp secures the cantilever support in place.

The mount carried by the cantilever support includes a backing plate and a foot plate. The foot plate has a pair of spaced apart slots through which bolts are inserted to be threaded into holes proved therefore in the cantilever support. Another slot provided in a member projecting rearwardly from the backing plate and from the foot plate has flanges on opposite sides thereof to allow them to slide beneath the head of a bolt securing the cantilever support to the upright portion of the clamp.

The foot plate extends at right angles to the backing plate and is formed as a one piece member with the backing plate, of plastic or other suitable material.

A pad is preferably fixed to the backing plate. The pad includes raised shoulders at opposite sides thereof that taper to a central area. The configuration of shoulders and recessed central area is provided to properly position a two-way radio or other such device centrally against the backing plate. The pad may be bonded or otherwise affixed to the backing plate.

The upper back end of the backing plate is provided with a central recessed portion that makes the upper edge of the backing plate thin to allow a clip on the back of a two-way radio or the like, to slide down over the backing plate. Transverse ribs in the lower portion of the recessed area provide better gripping for the clip, if such clip is used.

Additional objects and features of the invention will become apparent to a person skilled in the art to which the invention pertains from the drawings, detailed description and claims.

### BRIEF DESCRIPTION OF THE FIGURES OF THE DRAWINGS

In the Drawings

FIG. 1 is pictorial view of the all terrain vehicle portable radio mount of the invention shown secured to a vehicle handlebar;

FIG. 2, an exploded perspective view of the all terrain vehicle portable radio mount of the invention;

FIG. 3, a front elevation view of the support plate;

FIG. 4, a side elevation view of the support plate; and

FIG. 5, a rear elevation view of the support plate.

### DETAILED DESCRIPTION

Referring Now to the Drawings

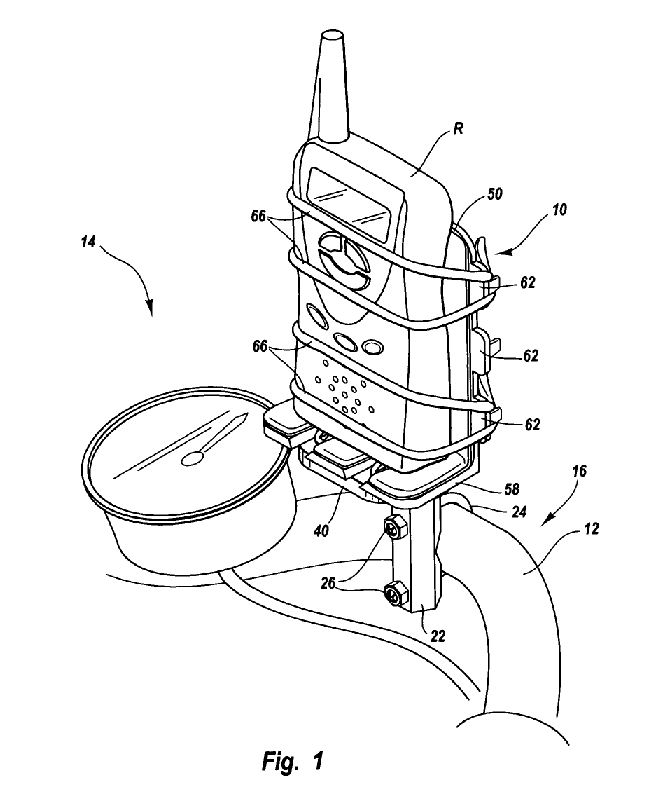

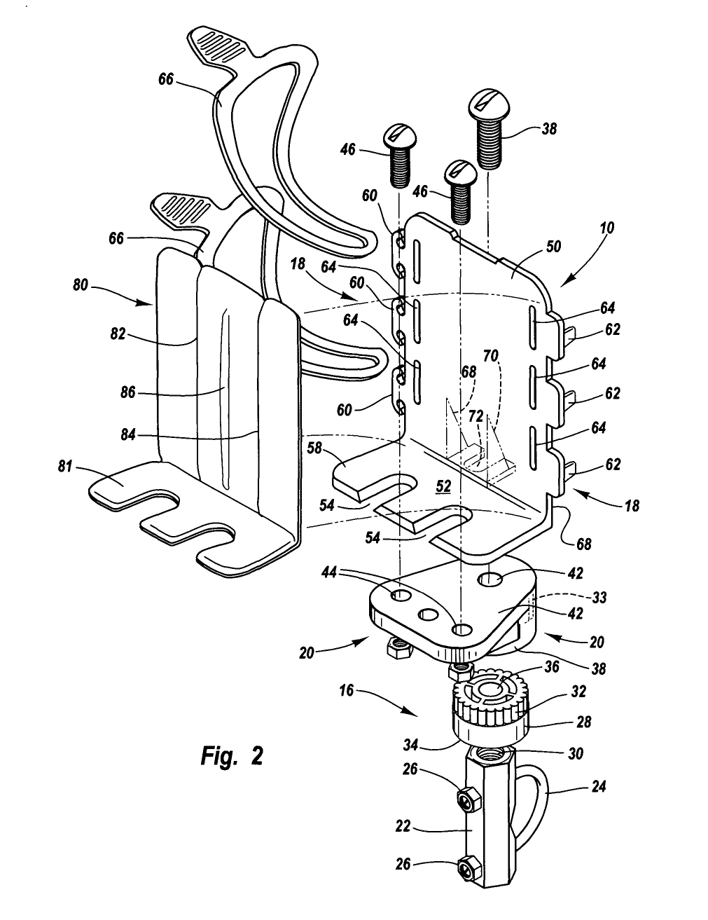

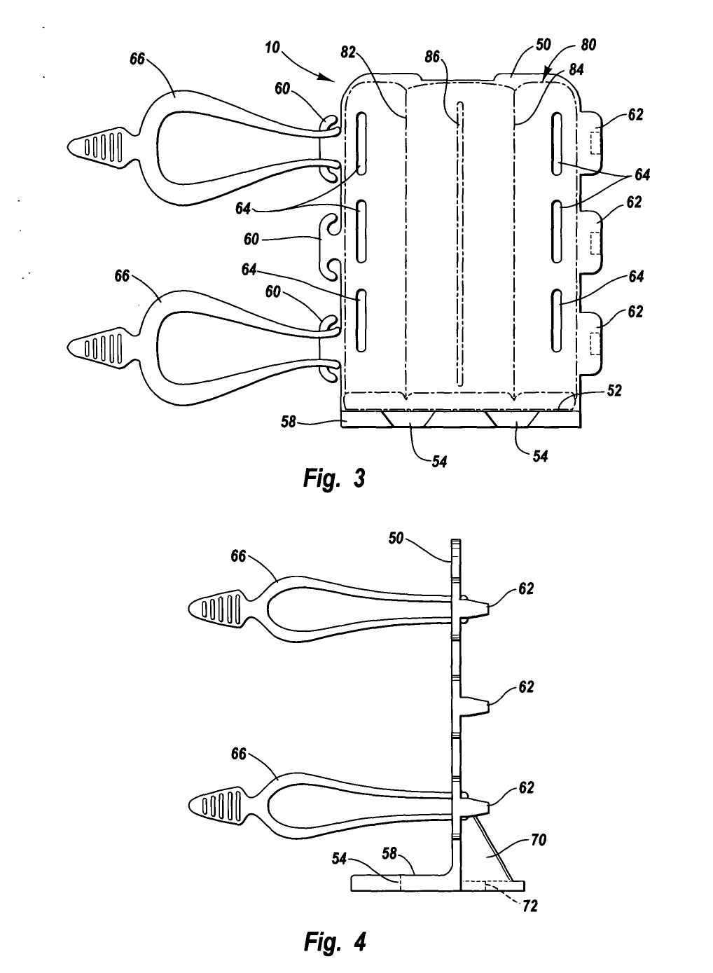

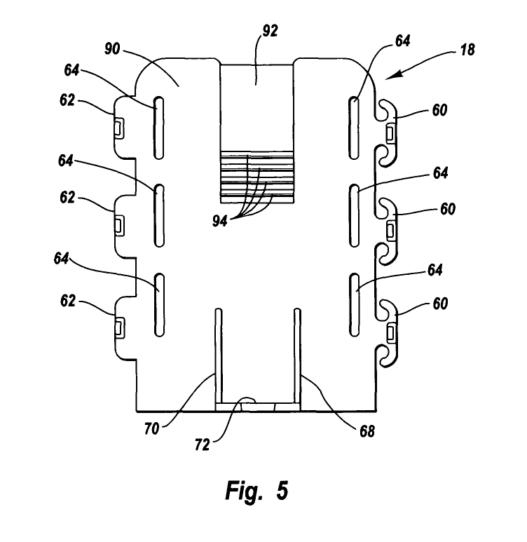

In the illustrated preferred embodiment of the all terrain vehicle portable radio mount of the invention, the portable mount is shown generally at 10. As best shown in FIG. 1, the portable mount is secured to a handlebar 12 of an all terrain vehicle 14, shown fragmentarily. As shown in FIG. 1, the portable all terrain vehicle portable radio mount holds a two-way radio R, or the like, in place, mounted on a handlebar 12 of the vehicle.

A base support 16 is attached to the handlebar 12 and a bracket holder 18 supports the two-way radio R. A cantilever support 20 interconnects the base support 16 and the bracket holder 18.

Base support 16 includes a support post 22 having a hexagonal exterior shape and spaced apart holes therethrough to allow the legs of a U-bolt 24 to be inserted through the post 22. Nuts 26 are threaded onto the ends of the U-bolt 24 as necessary for clamping of the handlebars 12 between the post 22 and the U-bolt 24.

A connector member 28 is secured to an end of the post 22.

Post 22 also has an interiorly threaded bore 30 running therethrough. Connector 28 has an upper end that is exteriorly splined as shown at 32 and a lower end 34 that is shaped to conform to and that will fit closely over an end of post 22. A bore hole 36 is provided through connector member 20 and a base 38 thereof that is interiorly splined at 32 to fit over and to interleave with the splines 32 on the connector 28. A hole 42, through the cantilever support 20 will align with the hole 36 through the connector and hole 30 in post 22 when the splined base 38 of the cantilever support 20 is positioned over the splines 32 of connector 28. The splines on the connector 28 and the cantilever support 20 cooperate to allow for selected rotational placement of the cantilever support 20 on the post 22 and locking of the members after such selected rotational placement.

Bracket holder 18 includes a backing plate 50 and a foot plate 52. The backing plate 50 and foot plate 52 are preferable made of a single piece of suitable plastic material. The foot plate extends at a right angle with respect to the backing plate and from one end of the backing plate.

T-shaped attachment members 60 are spaced along and project from one side of the backing plate. Corresponding hooks 62 are spaced along and project from the opposite side of the backing plate 50. Spaced apart slots 64 are provided at both sides of the backing plate 50. One or more elastic straps 66 are provided to be looped over one or more T-shaped connector member 60 and to be stretched to fit over one or more of the hooks 62. As shown, two elastic straps 66 are provided. The elastic straps can be stretched to fit directly across and connect to a hook 62 or the straps can be spread to fit over more than one of the hooks 62. The choice of how the straps 66 are to be stretched will normally be determined by the construction of the two-way radio or other device being secured to the all terrain portable radio mount. The flexibility of the resilient straps and the multiple choices of T-shaped connectors and hooks allows the user to position the bands of the straps so that it will not obscure the components of the attached two-way radio or other device that will adversely affect operation, viewing or operation of the device. Slots 64 at opposite sides of the backing plate 50 will also permit the use of conventional straps, not shown, to be used in securing a two-way radio or other device to the backing plate.

A pair of braces 68 and 70 are provided on a back side of the backing plate to support a slotted foot 72 that projects from the backing plate opposite to the projection of the foot plate 52. The base support 16 is assembled, as previously described, with one end of the connector 28 positioned over an end of the post 22 and the cantilever support 20 connected to the other end of the connector member 28. A bracket holder 18 is connected to the cantilever support 20 by positioning the slot in foot 72 over the hole 42 through cantilever support 20. Bolt 38 is then inserted through the slot of foot 72, the hole 42 of cantilever support 20, the bore 36 of the connector member 28 and is threaded into the interiorly threaded bore 30 of post 22.

The slots 54 of foot plate 52 are aligned over holes 44 through the cantilever support 20 and bolts 46 are inserted through the slots 54 and are threaded into the holes 44 to further secure the bracket support 18 to the cantilever support 20, bracket support 18 to the cantilever support 20, connector 28 and base support 16.

A cushioned backing member 80 may be provided to overlay the front surface of the backing plate 50. Backing member 80 provides a cushioned surface with enlarged spaced apart sides 82 and 84 and a central area 86 of reduced thickness. When a two-way radio, or the like, is positioned against the pad of the member 80 the enlarged outer sections and smaller central section work to center the radio against the member 80 and the backing plate 50. A slotted pad foot 81 may be provided at the lower end of the backing member 80.

The back surface 90 of backing plate 50 of the bracket holder 18 has a notch 92 formed adjacent a top end of an edge thereof. The notch 92 provides an area to receive a clip (not shown) on a radio, or the like, if a radio is so equipped. Ribs 94, at the bottom of the notch, extend across the notch and will be engaged by the clip to better secure the clip to the backing member.

In use, the all terrain vehicle portable radio mount 10 is secured to the handlebars of an off-highway vehicle, such as an all terrain vehicle using the clamp 24 and the mount is set to provide convenient use of a rider of the vehicle. This is done by turning the clamp on the handlebars, angularly setting the connector 16 with regard to the post 22, angularly setting the cantilever support 20 with respect to the connector 16 and positioning the bracket holder 18 on the cantilever support 20. The two-way radio, not shown, is positioned against the backing plate 50 and is held in place by stretching resilient straps 66 between connectors 60 and posts 62, across the radio.

Although a preferred form of our invention has been herein disclosed it is to be understood that the present disclosure is by way of example and variations are possible. without departing from the subject matter coming within the scope of the following claims, which subject matter we regard as our invention.

1. An All terrain vehicle portable radio mount comprising
a base support including clamping means for clamping to the handlebar of a vehicle;
a bracket holder including means to secure a two-way radio, or the like, thereto; and
a connector member including securement means to connect at selected rotational angles to said base support and securement means to connect said bracket holder at selected rotational angles and means to lock said base support, connector member with bracket holder against rotational movement with respect to one another.

2. An all terrain vehicle portable radio mount as in claim 1, wherein
the bracket holder includes a backing plate;
a foot plate extending at a right angle to one edge of said backing plate;
attachment means spaced along one side of said backing plate;
hooks spaced along an opposite side of said backing plate; and
at least one resilient band attached to said attachment means and stretchable to connect to said hooks.

3. An all terrain vehicle portable radio mount as in claim 2, wherein the clamping means comprises
a post having a non-circular outer surface, an interiorly threaded bore and a pair of spaced apart holes extending through the post transverse said interiorly threaded bore; and
a U-bolt having legs inserted through said spaced apart holes and nuts threaded onto said legs.

4. An all terrain vehicle portable radio mount as in claim 3, wherein
the connector member has a bore extending into a bottom end thereof and conforming in shape to and fitting snugly over an upper end of the post, a multiple splined exterior surface at the other end of the connector and a hole through said connector;
a cantilever support having a receptacle with multiple interiorly splines in a bottom thereof to fit snugly over the multiple splined end of the connector and a hole through said receptacle to align with the holes through the connector member and the interiorly threaded bore in the post; and
a bolt inserted through said hole through the receptacle and said connector member and threaded into said bore of said post.

5. An all terrain vehicle portable radio mount as in claim 4, further comprising a cushion pad overlying a front face of the backing plate.

6. An all terrain vehicle portable radio mount as in claim 5, wherein the cushion pad is enlarged at opposite sides thereof and of reduced thickness between said enlarged sides.

7. An all terrain vehicle portable radio mount as in claim 6, wherein
the backing plate has a notch formed in a rear surface thereof at the end opposite the foot plate whereby the thickness of the backing plate is reduced at said notch to receive a support clip of a portable radio.

8. An all terrain vehicle portable radio mount as in claim 7, wherein
the foot plate has spaced apart notches extending therein, the cantilever support has spaced apart threaded holes to receive bolts inserted through the spaced apart notches in the foot plate and threaded onto the spaced apart threaded holes in the foot plate; and wherein
the backing plate has a slotted foot extending centrally from a bottom of said backing plate and opposite to said foot plate, whereby said slotted plate will extend beneath the head of said bolt inserted through said cantilever support, the connector member and into the post.
